(19) United States
(12) Patent Application Publication
(10) Pub. No.: US 2026/0084606 A1
(43) Pub. Date: Mar. 26, 2026

(54) CONTROL METHOD AND SYSTEM FOR VEHICLE-MOUNTED REFRIGERATOR, RELATED DEVICE AND VEHICLE

(71) Applicant: BEIJING CHEHEJIA AUTOMOBILE TECHNOLOGY CO., LTD., Beijing (CN)

(72) Inventors: Ziwen ZHANG, Belling (CN); Peng Qiu, Beijing (CN); Ziyi XU, Beliing (CN)

(21) Appl. No.: 19/103,857

(22) PCT Filed: Aug. 10, 2023
(86) PCT No.: PCT/CN2023/112314

§ 371 Date: Feb. 14, 2025

(30) Foreign Application Priority Data
Aug. 15, 2022 (CN) 202210977431.8

(51) Int. Cl. B60N 3/10; F25D 23/02; F25D 27/00; F25D 29/00

(52) U.S. Cl. CPC B60N 3/104; F25D 23/028; F25D 27/005; F25D 29/003; F25D 2400/02; F25D 2400/361

(57) ABSTRACT

A control method and system for a vehicle-mounted refrigerator, a related device, and a vehicle are disclosed. The method includes that: the display panel is enabled to send a door body operation instruction, a light operation instruction and a temperature operation instruction to the main control board; the main control board is enabled to control the door body to unlock or lock, control an illumination lamp in the box body to perform brightness adjustment, and control the box body and the compressor to perform temperature adjustment; the display panel is enabled to obtain a door body state, and the main control board is enabled to obtain a lighting state and a temperature state in the box body; and the main control board is enabled to send the lighting state and the temperature state to the display panel, and the display panel is enabled to visually display the states.

### CROSS-REFERENCE TO RELATED APPLICATIONS

This is a national stage of International Application No. PCT/CN2023/112314 filed on Aug. 10, 2023, which claims priority to Chinese patent application No. 202210977431.8 filed on Aug. 15, 2022. The disclosures of International Application No. PCT/CN2023/112314 and Chinese patent application No. 202210977431.8 are hereby incorporated by reference in their entireties.

### TECHNICAL FIELD

The disclosure relates to the technical field of vehicle-mounted refrigerators, and in particular to a method and system for controlling a vehicle-mounted refrigerator, a related device, and a vehicle.

### BACKGROUND

In the related art, a vehicle-mounted refrigerator has a single function, mainly because a control system related to the vehicle-mounted refrigerator and a control mode of the vehicle-mounted refrigerator are single. Most of vehicle-mounted refrigerators may be controlled to perform cooling only, and control systems thereof do not have capability of controlling other functions, such as visual display, heating, lighting, locking and unlocking a door body, or the like.

Based on this, there is required a solution which enables the vehicle-mounted refrigerator to control multiple extended functions.

### SUMMARY

In view of this, the purpose of the disclosure is to propose a method and system for controlling a vehicle-mounted refrigerator, a related device, and a vehicle.

Based on the above purpose, the disclosure provides a method for controlling a vehicle-mounted refrigerator, the method is applied to the vehicle-mounted refrigerator. The vehicle-mounted refrigerator includes a main control board, a display panel, a door body, a refrigerator body, and a compressor.

The method includes the following operations.

The display panel is enabled to send a door body operation instruction, a lighting operation instruction and a temperature operation instruction to the main control board.

The main control board is enabled to control the door body to be unlocked or locked according to the received door body operation instruction, control an illumination lamp in the refrigerator body to perform brightness adjustment according to the received lighting operation instruction, and control the refrigerator body and the compressor to perform temperature adjustment according to the received temperature operation instruction.

The display panel is enabled to acquire a door body state of the door body, and the main control board is enabled to acquire a lighting state of the illumination lamp and a temperature state in the refrigerator body.

The main control board is enabled to send the lighting state and the temperature state to the display panel, and the display panel is enabled to visually display the door body state, the lighting state and the temperature state.

Further, the operation of enabling the display panel to send the door body operation instruction, the lighting operation instruction and the temperature operation instruction to the main control board may include the following operations.

The display panel is enabled to send one of an unlocking instruction or a locking instruction to the main control board.

The display panel is enabled to send one of a lamp-on instruction, a lamp-off instruction or a brightness adjustment instruction to the main control board.

The display panel is enabled to send one of a heating instruction or a cooling instruction to the main control board.

Further, the main control board may be provided with a display screen, the display screen is provided with touch buttons, the display screen is controlled by a display screen driver preset in the display panel, and the touch buttons are controlled by a button detection module preset in the display panel.

Further, during the brightness adjustment, the display screen may display multiple brightness in different levels, each of the levels is represented by a respective one of the touch buttons, and a user clicks one of the touch buttons to generate the brightness adjustment instruction.

Further, the operation of enabling the main control board to control the door body to be unlocked or locked according to the received door body operation instruction may include the following operations.

The main control board is enabled to receive the door body operation instruction through a preset communication interface, and execute a preset motor driver according to the door body operation instruction.

A motor preset on the door body runs, in response to an execution of the motor driver.

A movement of the door body is controlled by running the motor.

Further, the operation of controlling the movement of the door body by running the motor may include the following operations.

The door body is controlled to be opened.

Alternatively, the door body is controlled to be sprung open by a certain distance.

Further, the operation of controlling the illumination lamp in the refrigerator body to perform brightness adjustment according to the received lighting operation instruction may include the following operations.

The main control board is enabled to receive the lighting operation instruction through a preset communication interface, and execute a preset lighting driver according to the lighting operation instruction.

The illumination lamp is controlled, in response to an execution of the light driver.

Further, the operation of controlling the refrigerator body and the compressor to perform temperature adjustment according to the received temperature operation instruction may include the following operations.

In response to the main control board having received the heating instruction through a preset communication interface, a preset heating control program is executed according to the heating instruction.

Power of a heating element preset on the refrigerator body is adjusted, in response to an execution of the heating control program.

The heating element performs heating according to the adjusted power.

Alternatively, in response to the main control board having received the cooling instruction through the preset communication interface, a preset cooling control program is executed according to the cooling instruction.

A compressor driver preset on the compressor is executed, in response to an execution of the cooling control program.

The compressor runs, in response to an execution of the compressor driver.

Cooling is performed in the refrigerator body, in response to a running of the compressor.

Further, the heating element may be a heating wire and a heating film.

Further, the compressor may also be provided with a fan.

Further, the operation of enabling the display panel to acquire the door body state of the door body, and enabling the main control board to acquire the lighting state of the illumination lamp and the temperature state in the refrigerator body may include the following operations.

The display panel is enabled to detect a magnetic value of a magnet preset on the door body according to a preset Hall sensor.

It is determined, according to the detected magnetic value, that the door body is in one of an unlocked state or a locked state.

After the main control board controls the illumination lamp to perform brightness adjustment, the main control board is enabled to collect a lighting feedback signal sent by the illumination lamp, and determine the lighting state according to the lighting feedback signal.

The main control board is enabled to receive a temperature feedback signal from a temperature sensor preset in the refrigerator body, and determine the temperature state according to the temperature feedback signal.

Further, the temperature sensor may include a heating monitoring thermistor and a cooling monitoring thermistor.

Based on the same inventive concept, the disclosure further provides a system for controlling a vehicle-mounted refrigerator, the system is configured to perform the method for controlling a vehicle-mounted refrigerator as described in any one of the above paragraphs.

The system includes a main control board, and a display panel, a door body, a refrigerator body and a compressor which are connected to the main control board.

The main control board is configured to: control the door body to be unlocked or locked according to the received door body operation instruction, control an illumination lamp in the refrigerator body to perform brightness adjustment according to the received lighting operation instruction, and control the refrigerator body and the compressor to perform temperature adjustment according to the received temperature operation instruction; acquire a lighting state of the illumination lamp and a temperature state in the refrigerator body; and send the lighting state and the temperature state to the display panel.

The display panel is configured to: send a door body operation instruction, a lighting operation instruction and a temperature operation instruction to the main control board; acquire a door body state of the door body; and visually display the door body state and the temperature state.

The door body is configured to: enable the main control board to receive the door body operation instruction through a preset communication interface, and execute a preset motor driver according to the door body operation instruction; run a motor preset on the door body, in response to an execution of the motor driver; and control a movement of the door body by running the motor.

Further, the motor may include: the motor being fixedly arranged on the door body and being electrically connected to the motor driver in the main control board.

Based on the same inventive concept, the disclosure further provides an electronic device, the electronic device includes a memory, a processor, and a computer program stored on the memory and executable on the processor. When the processor executes the computer program, the method for controlling a vehicle-mounted refrigerator as described in any one of the above paragraphs is implemented.

Based on the same inventive concept, the disclosure further provides a non-transitory computer-readable storage medium. The non-transitory computer-readable storage medium stores computer instructions, and the computer instructions are configured to enable a computer to perform the above method for controlling a vehicle-mounted refrigerator.

Based on the same inventive concept, the disclosure further provides a vehicle, the vehicle includes: a system for controlling a vehicle-mounted refrigerator or an electronic device, and the electronic device performs the method for controlling a vehicle-mounted refrigerator as described in any one of the above paragraphs.

It may be seen from the above descriptions that according to the method and system for controlling a vehicle-mounted refrigerator, the related device, and the vehicle provided in the disclosure, the main control board is enabled to control the door body, lighting and temperature based on the door body operation instruction, the lighting operation instruction and the temperature operation instruction sent by the display panel, which comprehensively considers the control logic of the main control board after multiple different functions are added: the main control board may control the door body based on the door body operation instruction, the main control board may control the illumination lamp based on the lighting operation instruction, the main control board may control the refrigerator body and the compressor based on the temperature operation instruction. It may be seen that according to the method, different operation instructions are executed by using different control programs integrated on the main control board, and thus the vehicle-mounted refrigerator are controlled through multiple functions.

Further, when different control functions are performed on the vehicle-mounted refrigerator, the display panel may obtain feedback states corresponding to different control functions: the lighting state, the door body state and the temperature state, and visually display each of the states to the user of the vehicle-mounted refrigerator.

### BRIEF DESCRIPTION OF THE DRAWINGS

In order to explain technical solutions in the disclosure or the related art more clearly, drawings required to be used in descriptions of embodiments or the related art will be briefly introduced below. It is apparent that the drawings in the following descriptions are only embodiments of the disclosure, and other drawings may also be obtained by those of ordinary skill in the art according to these drawings, without making creative effort.

FIG. 1 is a flowchart of a method for controlling a vehicle-mounted refrigerator according to an embodiment of the disclosure.

FIG. 2 is a schematic diagram of electrical connections of a system for controlling a vehicle-mounted refrigerator according to an embodiment of the disclosure.

FIG. 3 is a schematic structural diagram of an electronic device according to an embodiment of the disclosure.

### DETAILED DESCRIPTION

In order to make the purpose, technical solutions and advantages of the disclosure more clear, the disclosure will be further described in detail below in combination with specific embodiments and with reference to the drawings.

It should be noted that unless otherwise defined, technical terms or scientific terms used in the embodiments of the disclosure should have usual meanings understood by people with ordinary skills in the field to which the disclosure belongs. “First”, “second” and similar words used in the embodiments of the disclosure do not indicate any order, quantity or importance, instead, are only intended to distinguish different components. A word such as “include” or “contain” or the like means that an element or item appearing before the word encompasses elements or items appearing and listed after the word and their equivalents, without excluding other elements or items. A word such as “connect” or “connection” or the like is not limited to physical or mechanical connections, instead, may include electrical connections, whether they are direct or indirect. “up”, “down”, “left”, “right” or the like are only intended to indicate a relative positional relationship. When an absolute position of a described object changes, the relative positional relationship may also change correspondingly.

In the related art, it is still difficult for methods for controlling a vehicle-mounted refrigerator to meet requirements of actual use.

During implementation of the disclosure, the applicant found that main problems of existing methods for controlling a vehicle-mounted refrigerator are that the relevant vehicle-mounted refrigerator has a single function, mainly because a control system related to the vehicle-mounted refrigerator and a control mode of the vehicle-mounted refrigerator are single. Most of vehicle-mounted refrigerators may be controlled to perform cooling only, and control systems thereof do not have capability of controlling other functions, such as visual display, heating, lighting, locking and unlocking a door body, or the like.

Based on this, one or more embodiments in the disclosure provide a method for controlling a vehicle-mounted refrigerator.

The embodiments of the disclosure are described in detail below with reference to the drawings.

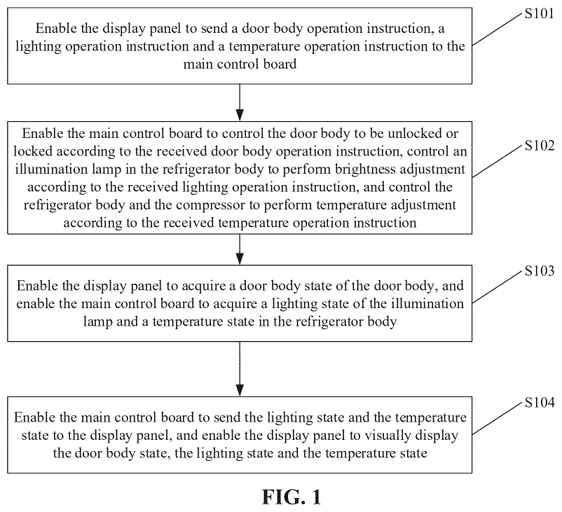

With reference to FIG. 1, a method for controlling a vehicle-mounted refrigerator according to an embodiment of the disclosure includes the following operations S101 to S104.

In operation S101, the display panel is enabled to send a door body operation instruction, a lighting operation instruction and a temperature operation instruction to the main control board.

In the embodiment of the disclosure, as a specific example, the vehicle-mounted refrigerator is provided with a main control board, a display panel, a door body, a refrigerator body, a compressor, etc.

In the embodiment of the disclosure, an illumination lamp is provided in the refrigerator body, to illuminate interior of the refrigerator body.

Further, the main control board is provided with a display screen, and the display screen is provided with touch buttons.

The display screen is controlled by a display screen driver preset in the display panel, and the touch buttons are controlled by a button detection module preset in the display panel.

Further, a user using the vehicle-mounted refrigerator may generate various operation instructions for controlling the vehicle-mounted refrigerator, by clicking the touch buttons in the display screen.

Further, the user may generate the door body operation instruction, the lighting operation instruction and the temperature operation instruction by operating the touch buttons.

In the embodiment of the disclosure, after any of the above instructions is generated, the display panel may send the generated instruction to the main control board, to enable the main control board to perform corresponding control according to the instruction.

Further, the door body operation instruction may specifically include an unlocking instruction and a locking instruction.

It may be seen that it is apparent that it is impossible for the door body to be in a locked state and an unlocked state simultaneously. Therefore, the user cannot input the unlocking instruction and the locking instruction simultaneously, and the main control board cannot perform the above two instructions simultaneously, either.

Further, when the door body is in the locked state, the user may input the unlocking instruction through the display screen, while cannot input the locking instruction; when the door body is in the unlocked state, the user may input the locking instruction through the display screen, while cannot input the unlocking instruction.

In the embodiment of the disclosure, the lighting operation instruction may specifically include a lamp-on instruction, a lamp-off instruction, and a brightness adjustment instruction.

It may be seen that it is apparent that it is impossible to perform all the above instruction operations on the lighting simultaneously. Therefore, when the illumination lamp is in an on state, the user may input the lamp-off instruction through the display screen, while cannot input the lamp-on instruction; when the illumination lamp is in an off state, the user may input the lamp-on instruction through the display screen, while cannot input the lamp-off instruction; when the lamp is in an on state, the user may also input the brightness adjustment instruction to adjust brightness of the illumination lamp. However, only one of the lamp-on instruction, the lamp-off instruction or the brightness adjustment instruction may be input at the same time, that is, the main control board may perform only one of instructions in the lighting operation instruction at the same time, too.

During the brightness adjustment, the display screen may display multiple brightness in different levels, each of the levels is represented by a respective one of the touch buttons, and the user clicks one of the buttons to generate the brightness adjustment instruction.

In the embodiment of the disclosure, the temperature operation instruction may specifically include a cooling instruction and a heating instruction.

It may be seen that it is apparent that it is impossible to cool and heat the refrigerator body simultaneously. Therefore, the user may input only one of the heating instruction or the cooling instruction at the same time, that is, the main control board may perform only one of instructions in the temperature operation instruction at the same time, too.

In the embodiment of the disclosure, when the user inputs any one of the unlocking instruction, the locking instruction, the lamp-on instruction, the lamp-off instruction, the brightness adjustment instruction, the heating instruction, or the cooling instruction through the touch buttons of the display panel, the display panel may send the instruction to the main control board.

In operation S102, the main control board is enabled to control the door body to be unlocked or locked according to the received door body operation instruction, control an illumination lamp in the refrigerator body to perform brightness adjustment according to the received lighting operation instruction, and control the refrigerator body and the compressor to perform temperature adjustment according to the received temperature operation instruction.

In the embodiment of the disclosure, the main control board is provided with a communication interface. The main control board may receive, through the communication interface, any operation instruction sent by the display panel to the main control board based on the foregoing operations, and perform corresponding control according to the instruction.

Further, when the display panel sends the door body operation instruction to the main control board, the main control board receives the door body operation instruction through the communication interface, and distinguishes the unlocking instruction and the locking instruction.

The main control board is also provided with a motor driver, and the motor driver may be a pre-edited driver program.

Further, the door body is also provided with a motor, and the motor is electrically connected to the motor driver and may be controlled by the motor driver.

Further, the main control board sends the received unlocking instruction or locking instruction to the motor driver, and the motor driver may execute a corresponding unlocking program or locking program according to the unlocking instruction or the locking instruction.

Further, by enabling the motor driver to execute the unlocking program, the motor on the door body may be controlled to be started, and the door body may be driven to be unlocked; when the motor driver executes the locking program, the motor on the door body may be controlled to be started, and the door body may be driven to be locked.

Further, after driving the door body to be unlocked, the motor on the door body may also control movement of the door body, to open the door body or spring open the door body by a certain distance.

In the embodiment of the disclosure, when the display panel sends the lighting operation instruction to the main control board, the main control board receives the door body operation instruction through the communication interface, and distinguishes the lamp-on instruction, the lamp-off instruction and the brightness adjustment instruction.

The main control board is also provided with a lighting driver, and the lighting driver may be a pre-edited driver program. In the embodiment of the disclosure, the illumination lamp in the refrigerator body may be a Light Emitting Diode (LED) lamp, and when the illumination lamp is a LED lamp, the lighting driver may be an LED driver. The illumination lamp is electrically connected to the lighting driver and may be controlled by the lighting driver.

Further, the main control board sends the received lamp-on instruction, lamp-off instruction or brightness adjustment instruction to the lighting driver, and the lighting driver may execute a corresponding lamp-on program, lamp-off program or brightness adjustment program according to the lamp-on instruction, the lamp-off instruction or the brightness adjustment instruction.

Further, by enabling the lighting driver to execute the lamp-on program, the lamp-off program or the brightness adjustment program, a digital analog signal input to the illumination lamp may be adjusted, thereby controlling to turn on or turn off the illumination lamp or perform the brightness adjustment on the illumination lamp in the refrigerator body.

In the embodiment of the disclosure, when the display panel sends the temperature operation instruction to the main control board, the main control board receives the temperature operation instruction through the communication interface, and distinguishes the heating instruction and the cooling instruction.

The main control board is also provided with a heating control program, and the refrigerator body is also provided with a heating element, for example, the heating element may be a heating wire and a heating film. The heating element is electrically connected to the heating control program, and may be controlled through the heating control program.

Further, when the main control board receives the heating instruction, the main control board sends the received heating instruction to the heating control program, and the heating control program may adjust current working power of the heating element according to the heating instruction.

Further, by adjusting the power of the heating element, temperature emitted by the heating element may be controlled, thereby heating interior of the refrigerator body.

Further, the compressor in the embodiment of the disclosure is provided with a compressor driver and a fan. The compressor driver is electrically connected to the main control board, and the compressor is physically connected to the refrigerator body.

In the embodiment of the disclosure, when the main control board receives the cooling instruction, the main control board sends the received cooling instruction to the compressor driver, and the compressor driver may run the compressor and the fan on the compressor according to the cooling instruction, to cool interior of the refrigerator body.

In operation S103, the display panel is enabled to acquire a door body state of the door body, and the main control board is enabled to acquire a lighting state of the illumination lamp and a temperature state in the refrigerator body.

In the embodiment of the disclosure, based on the above control of the door body of the vehicle-mounted refrigerator, lighting and temperature in the refrigerator body, in order to make control of the vehicle-mounted refrigerator more accurate and enable the user to acquire the state of the vehicle-mounted refrigerator, it is necessary to acquire a current door body state of the door body, the lighting state of the illumination lamp and the temperature state in the refrigerator body respectively.

In the embodiment of the disclosure, the display panel is also provided with a Hall sensor, the door body is also provided with a magnet, and a magnetic value of the magnet may be detected by the Hall sensor.

It may be seen that a distance between the door body and the display panel is different from each other when the door body is in the locked state and when the door body is in the unlocked state. Therefore, in the above two states, magnetic values that may be detected by the Hall sensor are different. Therefore, it may be determined, according to the magnetic value detected by the Hall sensor on the display panel, whether the door body is in the unlocked state or the locked state.

In the embodiment of the disclosure, based on the brightness adjustment of the illumination lamp performed by the main control board in the foregoing operations, after the lighting driver of the main control board sends a digital analog signal, a lighting feedback signal of the illumination lamp may also be collected, and it is determined, according to the lighting feedback signal, whether the illumination lamp is in an off state or an on state at present. Further, the main control board may determine a current brightness, that is, a current brightness level, according to the feedback signal when the illumination lamp is in the on state.

In the embodiment of the disclosure, the refrigerator body is also provided with a temperature sensor, to monitor temperature in the refrigerator body. The temperature sensor may be two Negative Temperature Coefficient (NTC) thermistors, which are arranged separately and are a heating-NTC (heating monitoring thermistor) and a cooling-NTC (cooling monitoring thermistor) respectively.

Further, the main control board is also provided with a temperature detection module, and the temperature detection module may be a pre-edited program.

The heating-NTC is electrically connected to the temperature detection module, the temperature detection module may receive temperature during heating from the heating-NTC and use the temperature as a temperature state of current heating in the refrigerator body.

Further, the cooling-NTC is electrically connected to the compressor driver, and the compressor driver may receive temperature during cooling from the cooling-NTC.

Further, the temperature during cooling will be sent to the main control board, and the main control board may use the temperature information as a temperature state of current cooling in the refrigerator body.

In operation S104, the main control board is enabled to send the lighting state and the temperature state to the display panel, and the display panel is enabled to visually display the door body state, the lighting state and the temperature state.

In the embodiment of the disclosure, based on the above-acquired door body state, lighting state and temperature state, the display panel may visually display them to the user.

In the embodiment of the disclosure, the main control board may send the acquired lighting state and temperature state to the display panel through the communication interface of the main control board.

Further, the display panel stores the acquired door body state, lighting state and temperature state in the display screen driver, and enables the display screen driver to visually display them in the display screen, to enable the user to clearly view current various states of the vehicle-mounted refrigerator.

It may be seen that according to the method for controlling a vehicle-mounted refrigerator in the embodiment of the disclosure, the main control board is enabled to control the door body, lighting and temperature based on the door body operation instruction, the lighting operation instruction and the temperature operation instruction sent by the display panel, which comprehensively considers the control logic of the main control board after multiple different functions are added: the main control board may control the door body based on the door body operation instruction, the main control board may control the illumination lamp based on the lighting operation instruction, the main control board may control the refrigerator body and the compressor based on the temperature operation instruction. It may be seen that according to the method, different operation instructions are executed by using different control programs integrated on the main control board, and thus the vehicle-mounted refrigerator are controlled through multiple functions.

Further, when different control functions are performed on the vehicle-mounted refrigerator, the display panel may obtain feedback states corresponding to different control functions: the lighting state, the door body state and the temperature state, and visually display each of the states to the user of the vehicle-mounted refrigerator.

It should be noted that the method of the embodiment of the disclosure may be performed by a single device, such as a computer or server, etc. The method of the embodiment may also be applied in a distributed scenario, and is completed by multiple devices cooperating with each other. In case of the distributed scenario, one of multiple devices may perform only one or more operations in the method of the embodiment of the disclosure, and multiple devices may interact with each other to complete the method.

It should be noted that some embodiments of the disclosure have been described as above. Other embodiments fall within the scope of the appended claims. In some cases, actions or operations recited in the claims may be performed in an order different from that in the above embodiments, and may still achieve desired results. Furthermore, processes depicted in the drawings do not necessarily require the specific order or consecutive order as illustrated, to achieve desirable results. In some implementations, multitask processing and parallel processing are also possible or may be advantageous.

Based on the same inventive concept, corresponding to the method of any of the above embodiments, an embodiment of the disclosure further provides a system for controlling a vehicle-mounted refrigerator.

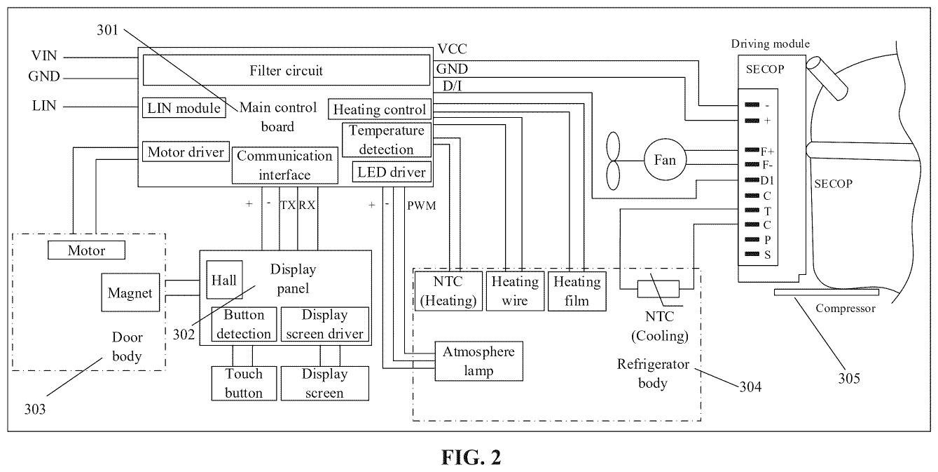

With reference to FIG. 2, the system for controlling a vehicle-mounted refrigerator performs the method described in any of the foregoing embodiments.

The system for controlling a vehicle-mounted refrigerator includes a main control board, and a display panel, a door body, a refrigerator body and a compressor which are connected to the main control board.

The main control board is configured to: control the door body to be unlocked or locked according to the received door body operation instruction, control an illumination lamp in the refrigerator body to perform brightness adjustment according to the received lighting operation instruction, and control the refrigerator body and the compressor to perform temperature adjustment according to the received temperature operation instruction; acquire a lighting state of the illumination lamp and a temperature state in the refrigerator body; and
send the lighting state and the temperature state to the display panel.

The display panel is configured to: send a door body operation instruction, a lighting operation instruction and a temperature operation instruction to the main control board;
acquire a door body state of the door body; and
visually display the door body state and the temperature state.

The door body is configured to: enable the main control board to receive the door body operation instruction through a preset communication interface, and execute a preset motor driver according to the door body operation instruction;
run a motor preset on the door body, in response to an execution of the motor driver; and
control a movement of the door body by running the motor.

In other embodiments of the disclosure, the motor includes:
the motor being fixedly arranged on the door body and being electrically connected to the motor driver in the main control board.

For the convenience of descriptions, when the above apparatus is described, the above apparatus is divided into various modules based on their functions, and the modules are described respectively. Of course, when the embodiments of the disclosure are implemented, the functions of the modules may be implemented in the same or multiple software and/or hardware.

The apparatus of the above embodiment is configured to implement the corresponding method for controlling a vehicle-mounted refrigerator in any of the foregoing embodiments, and have advantageous effects of corresponding method embodiments, which are not elaborated here.

Based on the same inventive concept, corresponding to the method of any of the above embodiments, an embodiment of the disclosure further provides an electronic device, the electronic device includes a memory, a processor, and a computer program stored on the memory and executable on the processor, and when the processor executes the program, the method for controlling a vehicle-mounted refrigerator as described in any of the above embodiments is implemented.

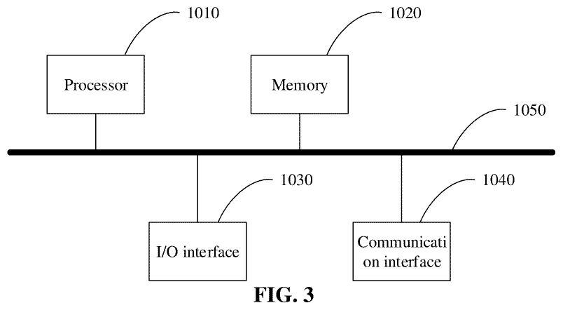

FIG. 3 illustrates a schematic diagram of a more specific hardware structure of an electronic device provided in the embodiment. The device may include a processor 1010, a memory 1020, an input/output (I/O) interface 1030, a communication interface 1040, and a bus 1050. The processor 1010, the memory 1020, the I/O interface 1030 and the communication interface 1040 implement mutual communication and connection within the device through the bus 1050.

The processor 1010 may be implemented in form of a general-purpose Central Processing Unit (CPU), a microprocessor, an Application Specific Integrated Circuit (ASIC), or one or more Integrated Circuits (ICs), or other forms, and is configured to perform relevant programs to implement the technical solutions provided in the embodiments of the disclosure.

The memory 1020 may be implemented in form of a Read Only Memory (ROM), a Random Access Memory (RAM), a static storage device, a dynamic storage device, etc. The memory 1020 may store an operating system and other application programs. When the technical solutions provided in the embodiments of the disclosure are implemented through software or firmware, relevant program codes are stored in the memory 1020 and are called and executed by the processor 1010.

The I/O interface 1030 is configured to connect an I/O module to implement information input and output. The I/O module may be configured in the device as a component (not illustrated in the figure), or may be externally connected to the device to provide corresponding functions. Input devices may include a keyboard, a mice, a touch screen, a microphone, various sensors, or the like, and output devices may include a display, a speaker, a vibrator, an indicator lamp, etc.

The communication interface 1040 is configured to connect a communication module (not illustrated in the figure) to implement communication and interaction between this device and other devices. The communication module may implement communication in a wired way (such as a Universal Serial Bus (USB), a network cable, etc.) or in a wireless way (such as a mobile network, Wireless Fidelity (WIFI), Bluetooth, etc.).

The bus 1050 includes a path which transmits information between various components of the device (such as the processor 1010, the memory 1020, the I/O interface 1030, and the communication interface 1040).

It should be noted that the above device only illustrates the processor 1010, the memory 1020, the I/O interface 1030, the communication interface 1040 and the bus 1050; however, during specific implementation, the device may further include other components necessary to implement normal operation. Furthermore, it may be understood by those skilled in the art that the above device may also include only components necessary to implement the solutions of the embodiments of the disclosure, and does not necessarily include all components illustrated in the figure.

The apparatus of the above embodiment is configured to implement the corresponding method for controlling a vehicle-mounted refrigerator in any of the foregoing embodiments, and have advantageous effects of corresponding method embodiments, which are not elaborated here.

Based on the same inventive concept, corresponding to the method of any of the above embodiments, an embodiment of the disclosure further provides a vehicle, the vehicle includes a system for controlling a vehicle-mounted refrigerator, or an electronic device, and the electronic device performs the method for controlling a vehicle-mounted refrigerator as described in any one of the above paragraphs.

Based on the same inventive concept, corresponding to the method of any of the above embodiments, an embodiment of the disclosure further provides a non-transitory computer-readable storage medium, the non-transitory computer-readable storage medium stores computer instructions, and the computer instructions are configured to enable a computer to perform the method for controlling a vehicle-mounted refrigerator as described in any of the above embodiments.

The computer-readable medium in the embodiment of the disclosure includes permanent and non-permanent, mobile and non-mobile media, and information storage may be implemented by any method or technology. The information may be computer-readable instructions, data structures, program modules, or other data. Examples of the storage medium of the computer include, but are not limited to a Phase change RAM (PRAM), a Static RAM (SRAM), a Dynamic RAM (DRAM), other types of RAMs, a ROM, an Electrically Erasable Programmable ROM (EEPROM), a flash memory or other memory technologies, a Compact Disc-Read Only Memory (CD-ROM), a Digital Versatile Disc (DVD) or other optical storage, a magnetic tape cassette, a tape disk storage or other magnetic storage devices, or any other non-transmission media, which may be configured to store information that may be accessed by a computing device.

The computer instructions stored in the storage medium of the above embodiment are configured to enable the computer to perform the method for controlling a vehicle-mounted refrigerator as described in any of the above embodiments, and have advantageous effects of corresponding method embodiments, which are not elaborated here.

It should be understood by those of ordinary skill in the art that discussion of any of the above embodiments is only exemplary, and is not intended to imply that the scope of the disclosure (including the claims) is limited to these examples; with the concept of the disclosure, the above embodiments or technical features in different embodiments may also be combined there-between, operations may be implemented in any order, and there are many other variations of different aspects of the embodiments of the disclosure as described above, which are not provided in detail for the sake of brevity.

Furthermore, in order to simplify explanation and discussion, and in order not to be difficult to understand the embodiments of the disclosure, well-known power supplies/ground connections with IC chips and other components may be or may not be illustrated in the provided figures. Furthermore, apparatuses may be illustrated in form of block diagrams, to avoid the embodiments of the disclosure from being difficult to be understood, and this also considers the following fact: details on implementations of these apparatuses in block diagrams are highly dependent on a platform in which the embodiments of the disclosure will be implemented (that is, these details should fully fall within the scope of understanding of those skilled in the art). In case that specific details (such as circuits) are set forth to describe exemplary embodiments of the disclosure, it is apparent to those skilled in the art that the embodiments of the disclosure may be implemented without these specific details or with these specific details changed. Therefore, these descriptions should be considered to be illustrative rather than restrictive.

Although the disclosure has been described in combination with specific embodiments thereof, many alternatives, modifications and variations of these embodiments will be apparent to those of ordinary skill in the art according to the foregoing descriptions. For example, other memory architectures such as DRAM may use the discussed embodiments.

The embodiments of the disclosure are intended to encompass all such alternatives, modifications and variations that fall within a broad scope of the appended claims. Therefore, any omission, modification, equivalent substitution, improvements, or the like made within the spirit and principle of the embodiments of the disclosure should be included in the scope of protection of the disclosure.

1. A method for controlling a vehicle-mounted refrigerator, applied to the vehicle-mounted refrigerator, wherein the vehicle-mounted refrigerator comprises a main control board, a display panel, a door body, a refrigerator body, and a compressor,
the method comprising:
enabling the display panel to send a door body operation instruction, a lighting operation instruction and a temperature operation instruction to the main control board;
enabling the main control board to control the door body to be unlocked or locked according to the received door body operation instruction, control an illumination lamp in the refrigerator body to perform brightness adjustment according to the received lighting operation instruction, and control the refrigerator body and the compressor to perform temperature adjustment according to the received temperature operation instruction;
enabling the display panel to acquire a door body state of the door body, and enabling the main control board to acquire a lighting state of the illumination lamp and a temperature state in the refrigerator body; and
enabling the main control board to send the lighting state and the temperature state to the display panel, and enabling the display panel to visually display the door body state, the lighting state and the temperature state.

2. The method of claim 1, wherein enabling the display panel to send the door body operation instruction, the lighting operation instruction and the temperature operation instruction to the main control board comprises:
enabling the display panel to send one of an unlocking instruction or a locking instruction to the main control board;
enabling the display panel to send one of a lamp-on instruction, a lamp-off instruction or a brightness adjustment instruction to the main control board; and
enabling the display panel to send one of a heating instruction or a cooling instruction to the main control board.

3. The method of claim 2, wherein the main control board is provided with a display screen, the display screen is provided with touch buttons, the display screen is controlled by a display screen driver preset in the display panel, and the touch buttons are controlled by a button detection module preset in the display panel.

4. The method of claim 3, wherein during the brightness adjustment, the display screen displays a plurality of brightness in different levels, each of the levels is represented by a respective one of the touch buttons, and a user clicks one of the touch buttons to generate the brightness adjustment instruction.

5. The method of claim 1, wherein enabling the main control board to control the door body to be unlocked or locked according to the received door body operation instruction comprises:
enabling the main control board to receive the door body operation instruction through a preset communication interface, and execute a preset motor driver according to the door body operation instruction;
running a motor preset on the door body, in response to an execution of the motor driver; and
controlling a movement of the door body by running the motor.

6. The method of claim 5, wherein controlling the movement of the door body by running the motor comprises:
controlling the door body to be opened; or controlling the door body to be sprung open by a certain distance.

7. The method of claim 1, wherein controlling the illumination lamp in the refrigerator body to perform brightness adjustment according to the received lighting operation instruction comprises:
enabling the main control board to receive the lighting operation instruction through a preset communication interface, and execute a preset lighting driver according to the lighting operation instruction; and
controlling the illumination lamp, in response to an execution of the light driver.

8. The method of claim 2, wherein controlling the refrigerator body and the compressor to perform temperature adjustment according to the received temperature operation instruction comprises:
in response to the main control board having received the heating instruction through a preset communication interface, executing a preset heating control program according to the heating instruction;
adjusting power of a heating element preset on the refrigerator body, in response to an execution of the heating control program; and
performing, by the heating element, heating according to the adjusted power, or
in response to the main control board having received the cooling instruction through the preset communication interface, executing a preset cooling control program according to the cooling instruction;
executing a compressor driver preset on the compressor, in response to an execution of the cooling control program;
running the compressor, in response to an execution of the compressor driver; and
performing cooling in the refrigerator body, in response to a running of the compressor.

9. The method of claim 8, wherein the heating element is a heating wire and a heating film.

10. The method of claim 8, wherein the compressor is further provided with a fan.

11. The method of claim 2, wherein enabling the display panel to acquire the door body state of the door body, and enabling the main control board to acquire the lighting state of the illumination lamp and the temperature state in the refrigerator body comprises:
enabling the display panel to detect a magnetic value of a magnet preset on the door body according to a preset Hall sensor;
determining, according to the detected magnetic value, that the door body is in one of an unlocked state or a locked state;
after the main control board controls the illumination lamp to perform brightness adjustment, enabling the main control board to collect a lighting feedback signal sent by the illumination lamp, and determine the lighting state according to the lighting feedback signal; and
enabling the main control board to receive a temperature feedback signal from a temperature sensor preset in the refrigerator body, and determine the temperature state according to the temperature feedback signal.

12. The method of claim 11, wherein the temperature sensor comprises a heating monitoring thermistor and a cooling monitoring thermistor.

13. A system for controlling a vehicle-mounted refrigerator, configured to perform the method of claim 1,
the system comprising a main control board, and a display panel, a door body, a refrigerator body and a compressor which are connected to the main control board,
wherein the main control board is configured to: control the door body to be unlocked or locked according to the received door body operation instruction, control an illumination lamp in the refrigerator body to perform brightness adjustment according to the received lighting operation instruction, and control the refrigerator body and the compressor to perform temperature adjustment according to the received temperature operation instruction; acquire a lighting state of the illumination lamp and a temperature state in the refrigerator body; and
send the lighting state and the temperature state to the display panel,
the display panel is configured to: send a door body operation instruction, a lighting operation instruction and a temperature operation instruction to the main control board;
acquire a door body state of the door body; and
visually display the door body state and the temperature state,
the door body is configured to: enable the main control board to receive the door body operation instruction through a preset communication interface, and execute a preset motor driver according to the door body operation instruction;
run a motor preset on the door body, in response to an execution of the motor driver; and
control a movement of the door body by running the motor.

14. The system of claim 13, wherein the motor comprises:
the motor being fixedly arranged on the door body and being electrically connected to the motor driver in the main control board.

15. An electronic device, comprising a memory, a processor, and a computer program stored on the memory and executable by the processor, wherein when the processor executes the computer program, the method of claim 1 is implemented.

16. A non-transitory computer-readable storage medium, having stored thereon computer instructions, wherein the computer instructions are configured to enable a computer to perform a method for controlling a vehicle-mounted refrigerator, wherein the vehicle-mounted refrigerator comprises a main control board, a display panel, a door body, a refrigerator body, and a compressor,
the method comprising:
enabling the display panel to send a door body operation instruction, a lighting operation instruction and a temperature operation instruction to the main control board;
enabling the main control board to control the door body to be unlocked or locked according to the received door body operation instruction, control an illumination lamp in the refrigerator body to perform brightness adjustment according to the received lighting operation instruction, and control the refrigerator body and the compressor to perform temperature adjustment according to the received temperature operation instruction;
enabling the display panel to acquire a door body state of the door body, and enabling the main control board to acquire a lighting state of the illumination lamp and a temperature state in the refrigerator body; and
enabling the main control board to send the lighting state and the temperature state to the display panel, and enabling the display panel to visually display the door body state, the lighting state and the temperature state.

17. A vehicle, comprising a system for controlling a vehicle-mounted refrigerator or the electronic device of claim 15, the system comprising a main control board, and a display panel, a door body, a refrigerator body and a compressor which are connected to the main control board,
wherein the main control board is configured to: control the door body to be unlocked or locked according to the received door body operation instruction, control an illumination lamp in the refrigerator body to perform brightness adjustment according to the received lighting operation instruction, and control the refrigerator body and the compressor to perform temperature adjustment according to the received temperature operation instruction; acquire a lighting state of the illumination lamp and a temperature state in the refrigerator body; and
send the lighting state and the temperature state to the display panel,
the display panel is configured to: send a door body operation instruction, a lighting operation instruction and a temperature operation instruction to the main control board;
acquire a door body state of the door body; and
visually display the door body state and the temperature state,
the door body is configured to: enable the main control board to receive the door body operation instruction through a preset communication interface, and execute a preset motor driver according to the door body operation instruction;
run a motor preset on the door body, in response to an execution of the motor driver; and
control a movement of the door body by running the motor.

18. The non-transitory computer-readable storage medium of claim 16, wherein when enabling the display panel to send the door body operation instruction, the lighting operation instruction and the temperature operation instruction to the main control board, the computer instructions are configured to perform operations of:
enabling the display panel to send one of an unlocking instruction or a locking instruction to the main control board;
enabling the display panel to send one of a lamp-on instruction, a lamp-off instruction or a brightness adjustment instruction to the main control board; and
enabling the display panel to send one of a heating instruction or a cooling instruction to the main control board.

19. The non-transitory computer-readable storage medium of claim 18, wherein the main control board is provided with a display screen, the display screen is provided with touch buttons, the display screen is controlled by a display screen driver preset in the display panel, and the touch buttons are controlled by a button detection module preset in the display panel.

20. The non-transitory computer-readable storage medium of claim 19, wherein during the brightness adjustment, the display screen displays a plurality of brightness in different levels, each of the levels is represented by a respective one of the touch buttons, and a user clicks one of the touch buttons to generate the brightness adjustment instruction.
